(19) United States
(12) Patent Application Publication
(10) Pub. No.: US 2026/0191386 A1
(43) Pub. Date: Jul. 9, 2026

(54) SYSTEMS AND METHODS FOR ACTIVE SUSPENSION FOR A ROBOTIC CLEANING DEVICE

(71) Applicant: SharkNinja Operating LLC, Needham, MA (US)

(72) Inventors: Derek Anguita Lessard, Dorchester, MA (US); Jacob Marc L’Heureux, South Boston, MA (US); Scott C. Teuscher, Advance, NC (US)

(21) Appl. No.: 19/129,004

(22) PCT Filed: Nov. 10, 2023
(86) PCT No.: PCT/US2023/037166

§ 371 Date: May 10, 2025

Related U.S. Application Data
(60) Provisional application No. 63/424,754, filed on Nov. 11, 2022.
(60) Provisional application No. 63/424,740, filed on Nov. 11, 2022.
(60) Provisional application No. 63/424,754, filed on Nov. 11, 2022.
(60) Provisional application No. 63/532,266, filed on Aug. 11, 2023.
(60) Provisional application No. 63/532,269, filed on Aug. 11, 2023.

(51) Int. Cl. A47L 11/40; A47L 11/28

(52) U.S. Cl. CPC A47L 11/4011; A47L 11/28; A47L 11/4066; A47L 11/4072; A47L 2201/06

(57) ABSTRACT

A method of controlling a robotic cleaning device. The method includes detecting, via one or more sensors, a soiled area in on a target surface for cleaning. The method includes activating an active suspension system to reduce the distance between a chassis of the robotic cleaning device and the target surface, thereby increasing pressure applied by a cleaning pad mounted to the chassis of the robotic cleaning device. The method includes monitoring, via one or more processors, one or more parameters of the robotic cleaning device to determine whether the one or more parameters is outside a threshold parameter range. The method includes adjusting the active suspension system if the one or more parameters is outside the threshold parameter range, and deactivating the active suspension system when the soiled area on the target surface is detected to be cleaned.

### CROSS-REFERENCE TO RELATED APPLICATIONS

This application is a 35 U.S.C. § 371 entry of PCT/US 2023/037166, filed Nov. 10, 2023, which claims the benefit of U.S. Provisional Application No. 63/424,754, filed Nov. 11, 2022; U.S. Provisional Application No. 63/424,740, filed Nov. 11, 2022; U.S. Provisional Application No. 63/532,266, filed Aug. 11, 2023 and U.S. Provisional Application No. 63/532,269, filed Aug. 11, 2023, the disclosures of which are incorporated by reference herein in their entirety.

### TECHNICAL FIELD

The present disclosure relates generally to the field of robotic cleaners and, more particularly, to suspension systems in robotic cleaners.

### BACKGROUND

The background description provided herein is for the purpose of generally presenting the context of the disclosure. The work of the presently named inventors, to the extent it is described in this background section, as well as aspects of the description that may not otherwise qualify as prior art at the time of filing, are neither expressly nor impliedly admitted as prior art against the present disclosure.

Within the field of robotic cleaning devices, various cleaning functionalities may be implemented to address a range of cleaning needs. For example, some robotic cleaning devices may include functionality for vacuum cleaning, wet cleaning, agitators brushes, etc. Robotic cleaners may operate in a variety of environments that may include varying terrain, floor types, debris, and other obstacles. Because many robotic cleaning devices may operate in autonomous and/or semi-autonomous modes, a need exists for the robotic cleaning devices to make automatic adjustments to maintain functionality in a wide variety of environments.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

In an embodiment, the disclosure describes a method of controlling a robotic cleaning device. The method may include detecting, via one or more sensors, a soiled area in on a target surface for cleaning. The method may include activating an active suspension system to reduce the distance between a chassis of the robotic cleaning device and the target surface, thereby increasing pressure applied by a cleaning pad mounted to the chassis of the robotic cleaning device. The method may include monitoring, via one or more processors, one or more parameters of the robotic cleaning device to determine whether the one or more parameters is outside a threshold parameter range. The method may include adjusting the active suspension system if the one or more parameters is outside the threshold parameter range and deactivating the active suspension system when the soiled area on the target surface is detected to be cleaned.

In another embodiment, the disclosure describes a method of controlling a robotic cleaning device. The method may include detecting a restricted mobility position of the robotic cleaning device. The method may include determining that an electrical current draw for a drive motor controlling rotation of one or more wheels of the robotic cleaning device is above a predetermined current range. The method may include activating an active suspension system to decrease the distance between a chassis of the robotic cleaning device and a target surface based on the determination that the electrical current draw for the drive motor is above the predetermined current range.

In another embodiment, the disclosure describes a method of controlling a robotic cleaning device. The method may include detecting a restricted mobility position of the robotic cleaning device and determining that an electrical current draw for a drive motor controlling rotation of one or more wheels of the robotic cleaning device is below a predetermined current range. The method may include activating an active suspension system to increase the distance between a chassis of the robotic cleaning device and a target surface based on the determination that the electrical current draw for the drive motor is below the predetermined current range.

### BRIEF DESCRIPTION OF THE DRAWINGS

Non-limiting and non-exhaustive embodiments are described in reference to the following drawings. The components in the figures are not necessarily to scale, emphasis instead being placed upon illustrating the principles of the disclosure. In the drawings, like reference numerals refer to like parts through all the various figures unless otherwise specified.

For a better understanding of the present disclosure, a reference will be made to the following detailed description, which is to be read in association with the accompanying drawings, wherein:

FIG. 1A is a partial cross-sectional side view of an embodiment of a robotic cleaner in accordance with the disclosure;

FIG. 1B is a front view of the robotic cleaner of FIG. 1A;

FIG. 2A is a top perspective view of the robotic cleaner of FIG. 1A;

FIG. 2B is an exploded view of the robotic cleaner of FIG. 1A;

FIG. 3A is a partial cross-sectional view of the robotic cleaner of FIG. 1A showing an embodiment of an active suspension system in a first position in accordance with the disclosure;

FIG. 3B is a partial cross-sectional view of the robotic cleaner of FIG. 1A showing the active suspension system of FIG. 3A in a second position;

FIG. 4A is a detailed view of the active suspension system of FIG. 3A in the first position;

FIG. 4B is a detailed view of the active suspension system of FIG. 3B in the second position;

FIG. 5 is a side view of another embodiment of an active suspension system in accordance with the disclosure;

FIG. 6 is a flow chart of an embodiment of a method for controlling an active suspension system of a robotic cleaner in accordance with the disclosure;

FIG. 7 is a flow chart of another embodiment of a method for controlling an active suspension system of a robotic cleaner in accordance with the disclosure;

FIG. 8 is a top cross-sectional view of another embodiment of an active suspension system in accordance with the disclosure;

FIG. 9 is a top cross-sectional view of another embodiment of an active suspension system in accordance with the disclosure;

FIG. 10 is a top cross-sectional view of another embodiment of an active suspension system in accordance with the disclosure;

FIG. 11 is a flow chart of another embodiment of a method for controlling an active suspension system of a robotic cleaner in accordance with the disclosure;

FIG. 12 is a flow chart of another embodiment of a method for controlling an active suspension system of a robotic cleaner in accordance with the disclosure; and

FIG. 13 is a flow chart of another embodiment of a method for controlling an active suspension system of a robotic cleaner in accordance with the disclosure.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meaning have otherwise been set forth herein.

### DETAILED DESCRIPTION

The present disclosure now will be described more fully hereinafter with reference to the accompanying drawings, which form a part hereof, and which show, by way of illustration, specific exemplary embodiments by which the disclosure may be practiced. This disclosure may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, although it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and includes plural references. The meaning of “in” includes “in” and “on.”

The disclosure describes, in some embodiments, an autonomous or semi-autonomous robot that may be configured to vacuum, wet clean, or otherwise clean floors, carpets, and/or other target surfaces in homes or other appropriate locations. In some embodiments, autonomous cleaning robots consistent with the disclosure may include a chassis and a transport drive system configured to autonomously or semi-autonomously transport cleaning elements over the target surface. The robot may be supported on the target surface by a plurality of wheels in rolling contact with the target surface, and the robot may include controls and drive elements configured to direct the robot to generally traverse the target surface in one or more directions. In some embodiments, the robot may include a drive device controlled by a controller and powered by one or more motors for performing autonomous or semi-autonomous movement over the target surface.

In some embodiments, the cleaning robot may include one or more cleaning modules. In embodiments with multiple cleaning modules, the cleaning modules may operate separately or in coordination. In some embodiments, the cleaning robot may include a dry cleaning module that may be configured to collect dry debris from the target surface and a wet cleaning module that may be configured to perform wet cleaning by applying a liquid, such as a cleaning fluid, onto a cleaning pad and using the cleaning pad to scrub the target surface. The surface cleaning robot may also include at least two containers or compartments that may store debris collected by the dry cleaning module and to store cleaning fluid that may be used by the wet cleaning module.

In some embodiments, the cleaning robot may include an active suspension system that may be configured to adjust the robot's ride height. The active suspension system may provide various benefits to the robot's performance, such as increased cleaning capabilities, efficiencies, improved mobility, improved range, and improved energy efficiency and/or battery life. For example, in some embodiments, the active suspension system may help optimize ride height to improve suction/sealing with a target surface and/or to maintain desired contact with the target surface and rotation speeds for agitator brushes. In some embodiments, a control method may include maintaining a desired, predetermined, or calculated engagement depth or interference distance between cleaning robot components (e.g., agitating members such as brushes) and a target surface. In some embodiments, a control method may include maintaining a substantially constant torque load on cleaning robot components such as an agitating motor or brush roll motor. Additionally, the active suspension system may provide improved mobility for the cleaning robot, such as by improving or optimizing ride height over target surfaces with varying properties and/or providing improved ability to travel over thresholds, cables, or other environmental obstacles. In some embodiments, the active suspension system may also provide for selectively lifting a cleaning pad (or other robot features) to reduce or prevent the interference with the target surface when not desired. For example, in some embodiments, the active suspension system may provide for lifting a soiled cleaning pad clear of a target surface, such as a rug or carpet, so as to reduce or eliminate transferring the soiling material to the target surface.

In some embodiments, the active suspension system described herein may provide hard stops to wheel modules of the robot that may allow the robot to vary ride height over different types of target surfaces. In some embodiments, this may be achieved without changing other features of the robot's suspension system. In other words, ride dampening and other suspension effects may still be utilized via other suspension components (e.g., springs, dampeners, etc.), but at variable heights. For example, in some embodiments, the active suspension system may provide tighter seals to certain target surfaces (e.g., bare floors, low-pile carpet, etc.) while still providing the ability to clear obstacles. In some embodiments, the target surface conditions may be determined by one or more sensors that may inform the optimal ride height for the given conditions and desired cleaning performance.

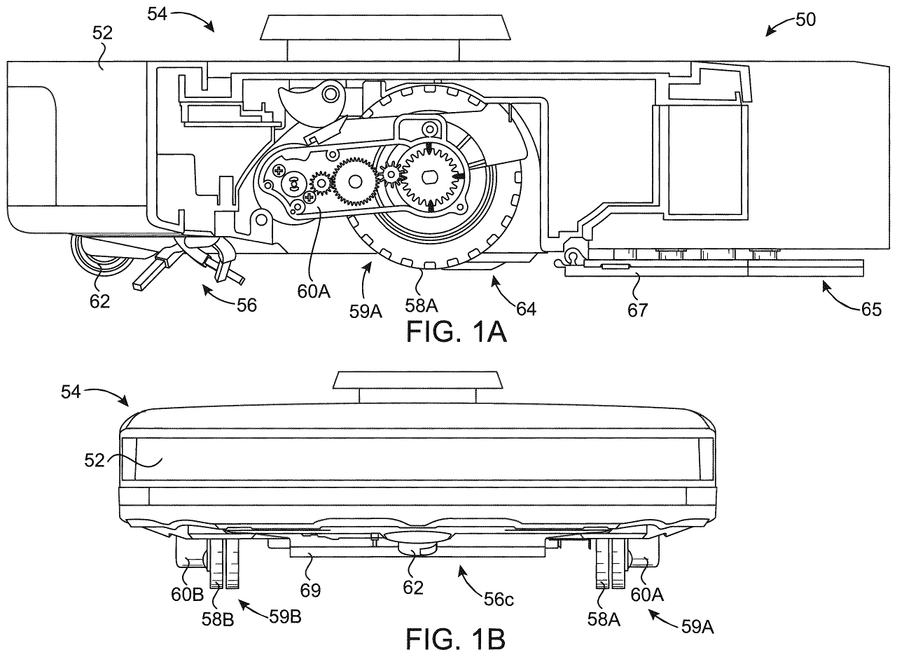

FIGS. 1A and 1B embodiments of a cleaning robot 50 that may include the active suspension system described herein. The cleaning robot 50 may include a generally round housing or chassis 52 that may have an upper portion 54 and a lower portion 56. In some embodiments, the upper portion 54 may include a user interface that may be used to initiate cleaning or other operations and/or provide indications of robot status (e.g., mode, battery life, errors, etc.). The cleaning robot 50 may include one or more driven wheel assemblies 59A, B that may include drive wheels 58A, B. The robot 50 may also include one or more caster wheels 62 coupled to the lower portion 56 of the chassis 52. In some embodiments, the wheels 58A, B may be independently rotatable about associated rotational axes and may be coupled to respective drive motors contained within each driven wheel assembly 59A, B. As such, in some embodiments, each wheel 58A, B may generally be described as being independently driven. In some embodiments, both wheels 58A, B may be driven with a single drive motor that may distribute power to the wheels via one or more drive shaft and/or differential, or the wheels may be driven by a separate motor (e.g., suction motor) having power split for various different robot components. In some embodiments, the cleaning robot 50 may be autonomously steered or controlled to maneuver over a target surface such as by drive signals from one or more controllers disposed on a control board on the robot. The drive signals may maneuver the cleaning robot 50 by, for example, adjusting the rotational speed of one of the plurality of wheels 58A, B relative to the other of the plurality of wheels.

Each wheel assembly 59A, B may include an arm 60A, B and a wheel 58A, B. Each arm 60A, B may have a proximate end rotatably coupled to the lower portion 56 of the chassis 52 or to a static portion of the wheel assembly. Each wheel 58A, B may be rotatably coupled to a distal end of each respective arm 60A, B substantially opposite the proximate end. In some embodiments, each wheel assembly 59A, B may include a drive motor that may be coupled to the arm 60A, B. In some embodiments, each wheel assembly 59A, B may also include one or more gears that may be configured to transmit power from each drive motor to each respective wheel 58A, B. In some embodiments, each proximate end of each respective arm 60A, B may be rotatable about the chassis 52 to raise and/or lower each respective wheel 58A, B. As described in more detail below, the active suspension system 100 may cause each proximate end of each respective arm 60A, B to pivot, lowering each wheel 58A, B, and thus selectively raising and/or lowering the chassis 52 with respect to the floor or other target surface.

In some embodiments, the cleaning robot 50 may also include a vacuum module 64, which may include a suction conduit 69, a dust cup, and a suction motor, among other components. The suction conduit 69 may be disposed on the lower portion 56 of the chassis 52 in opposed facing relationship to the floor or other target surface and may be fluidly coupled to the dust cup and the suction motor. In some embodiments, the suction motor may cause debris from the target surface to be suctioned into the suction conduit 69 and deposited into the dust cup for later disposal. An air exhaust port may be fluidly coupled to the suction motor. In various embodiments, the air exhaust port may be configured to prevent undesirable debris agitation, to direct debris, or to dry cleaning fluid.

In some embodiments, the robotic cleaner 50 may include a wet cleaning module 65 that may be permanently or removably affixed to the chassis 52. The wet cleaning module 65 may include a cleaning fluid tank and a wet cleaning pad 67. In some embodiments, as the cleaning robot 50 may travel across a floor or other target surface, the suction conduit 69 connected to the suction motor may collect dry debris from the floor while a liquid applicator of the wet cleaning module 65 may apply a cleaning fluid onto the wet cleaning pad 67. In some embodiments, the wet cleaning pad 67 may be raised and/or lowered with respect to the target surface, such as via raising or lowering the wheels 58A, B with the active suspension system disclosed herein so as to clean the targets surface with the wet cleaning pad.

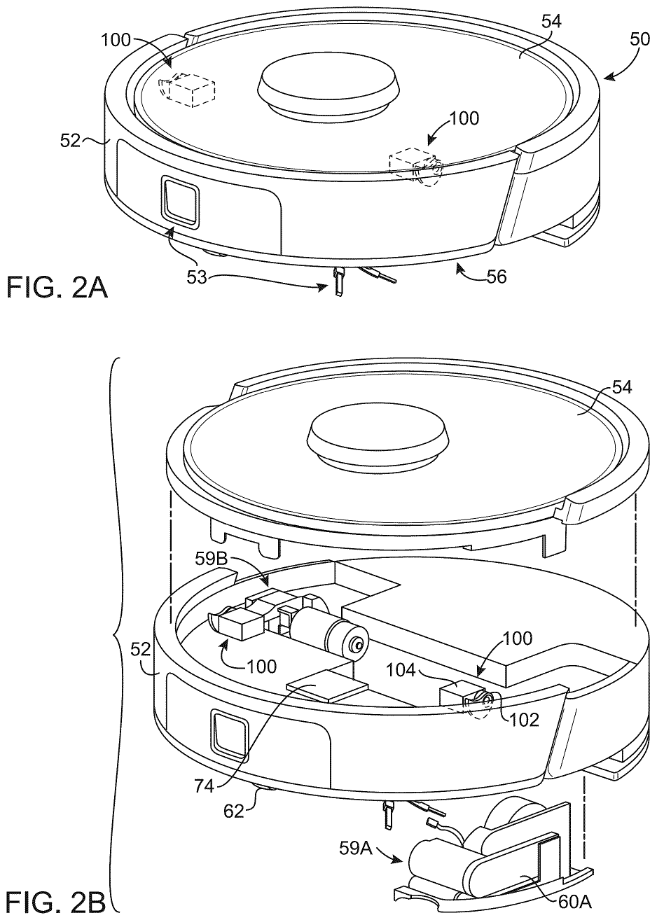

FIGS. 2A and 2B shows an embodiment of the cleaning robot 50 including an active suspension system 100. The active suspension system 100 may take various forms to raise and/or lower the wheels 58A, B with respect to chassis 52 of the cleaning robot 50. In some embodiments, the active suspension system 100 may be controlled by one or more controllers 74 that may be disposed in the wheel assembly 59A, B or elsewhere in the cleaning robot 50. In some embodiments, the controller may be a proportional-integral-derivative (PID) controller, or may be another type of suitable controlling device. In some embodiments, the controller 74 (e.g., PID controller) may be partially or entirely software-based, and may not require a separate controller device connected to the active suspension system. In some embodiments, the active suspension system 100 may include a closed-loop controller without any direct feedback. For example, such a controller may control the limits on wheel travel (e.g., up or down) without actually directly measuring the wheel position. In some embodiments, the controller (e.g., PID) inputs may be indirect measurements, such as brush roll current or cliff sensor data. The controller may be in electronic communication with one or more sensors 53 on the cleaning robot 50 that may provide information about the cleaning robot's environment, location, obstacles, and/or the properties of the floor or other target surface. In some embodiments, those sensors 53 may include proximity sensors, optical sensors, sonar, LIDAR, infrared (IR) sensors, ultrasonic sensors, 2D and/or 3D cameras, photosensors, etc. In some embodiments, one or more laser beams emitted from lasers disposed on the robot 50 may continuously or periodically scan the robot's surroundings and any returned reflections (visible or otherwise) may be detected by a camera disposed on the robot. Using a plurality of laser lines over time, the camera's detection of the laser returns may be constructed into a point cloud of laser returns from an obstacle or other environmental feature. The point cloud may be analyzed to determine characteristics of the detected object, such as physical dimensions (e.g., height), which may be used to determine desired positioning for the active suspension system 100.

In some embodiments, operation of other components of the cleaning robot 50 in electronic communication with the controller may provide additional information about the robot's environment, obstacles, floor conditions, or performance. In some embodiments, the controller may use such inputs to determine appropriate responsive actions by the active suspension system 100. For example, the controller may determine properties of the cleaning robot's 50 surroundings by monitoring electrical current, voltage, and/power usage by agitators or brush rolls in the vacuum module 64 over time. Depending on the brush roll's current draw, the controller 74 may determine whether the brush roll may be encountering too much or too little resistance and raise/lower the wheels accordingly. In another example, the controller 74 may use current or other power usage information from a suction motor to determine whether to raise/lower the wheels via the active suspension system to optimize the vacuum's seal and/or suction performance. Those of skill in the art will recognize that other inputs may also be used or taken into account when determining and positioning the wheel height and corresponding chassis clearance of the cleaning robot to most effectively perform a cleaning task or other activity.

### Cam System

FIGS. 2-5 show embodiments of an active suspension system 100 of the cleaning robot 50 wherein each wheel assembly 59A, B may include a rotatable cam 102 configured to be selectively driven by a cam motor 104 to raise/lower the wheels 58A, B with respect to the chassis 52 of the cleaning robot 50. In some embodiments, each wheel assembly 59 may include a passive suspension system that may include a spring 71 to a shock absorber. The spring 71 may dampen movements of the chassis 52 as the wheel 58 encounters debris or uneven surfaces. In some embodiments, the cam 102 of the active suspension system 100 may rotate between two or more positions to provide a movable hard stop that may allow the cleaning robot 50 to change how high the chassis 52 rides without changing other basic functionality of the cleaning robot's passive suspension system.

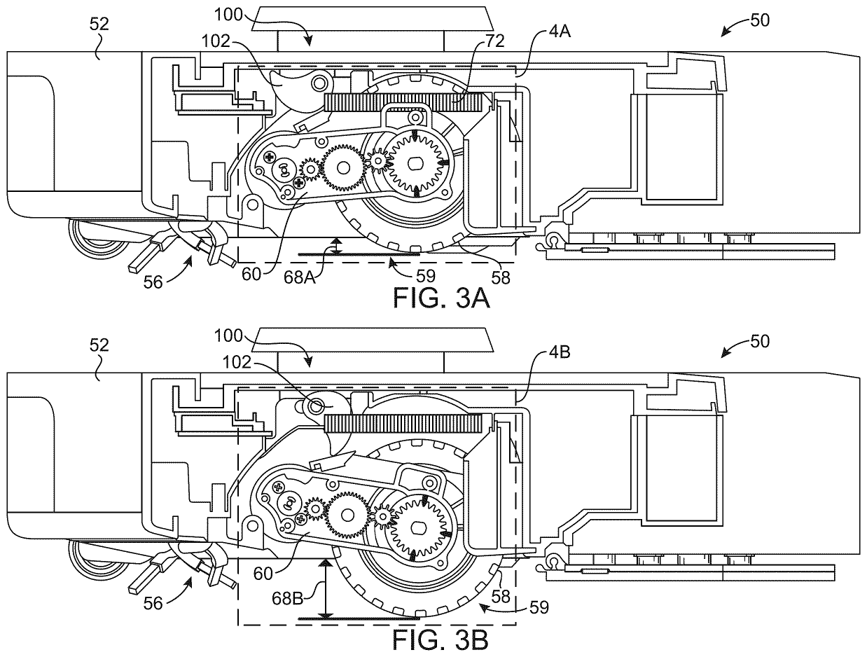

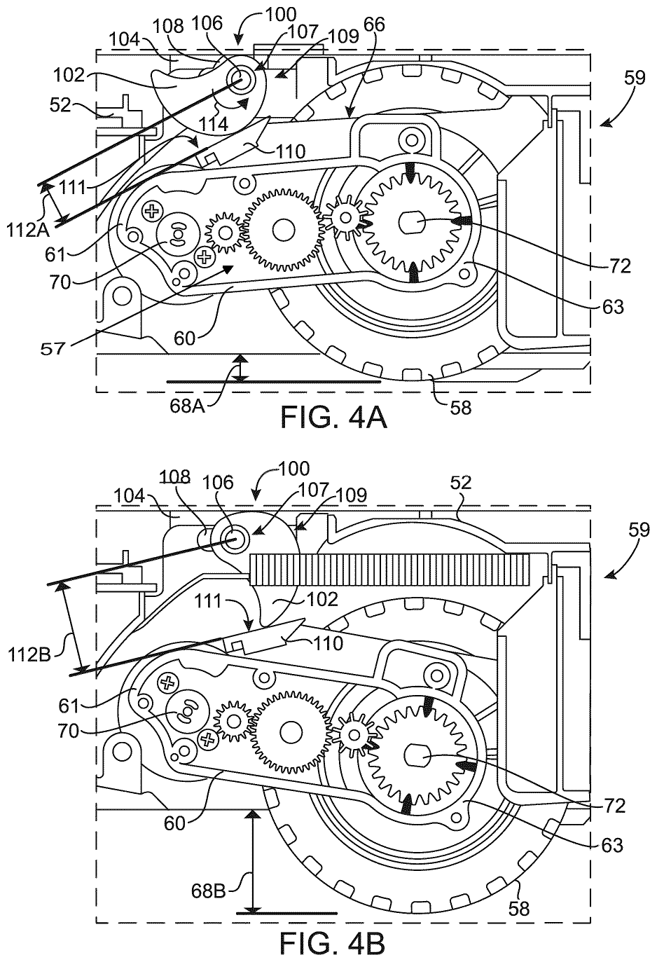

FIGS. 3A and 3B show an embodiment of how the active suspension system 100 may be a part of or may interact with the wheel assembly 59A and/or the passive suspension system, while FIGS. 4A and 4B show a more detailed depiction of the active suspension system. For ease of explanation, the description of FIGS. 3-5 refers to a wheel assembly 59 that could refer to any of wheel assemblies 59A, 59B, etc., and their respective components. In some embodiments, each wheel assembly 59 may include an arm 60 having a proximate end 61 and a distal end 63. The proximate end 61 of the arm 60 may be pivotally coupled to the chassis 52 via a pivot joint 70, and the distal end 63 may be rotatably coupled to the wheel 58 via a wheel axle 72. In some embodiments, the wheel 58 and axle 72 may be driven by one or more drive motors via a gear train 57 that may be disposed on or within the arm 60.

As mentioned above, in some embodiments, the active suspension system 100 may selectively move a hard stop for the wheel 58 between a first position shown in FIGS. 3A and 4A, and a second position, shown in FIGS. 3B and 4B. It is contemplated that, in some embodiments, the active suspension system 100 may move between the first position and the second position and may also hold the wheel in virtually any position between the first and second positions. Movement by the active suspension system 100 between the first position and the second position may increase and/or decrease a clearance height between the floor and the chassis 52. For example, the chassis 52 may have a first clearance height 68A when the active suspension system 100 is in the first position (FIGS. 3A and 4A), and may have a second clearance height 68B when the active suspension system is in the second position (FIGS. 3B and 4B), which may be greater than the first clearance height. In some embodiments, as shown in FIG. 4A, the active suspension system 100 may transition between the first and second positions as a result of the cam's 102 rotation. For example, FIG. 4A shows the cam 102 in a first rotational position that may correspond to the first position, and FIG. 4B shows the cam in a second rotational position that may correspond to the second position.

The active suspension system 100 may include a cam motor 104 that may be configured to selectively rotate the cam 102 between at least the first rotational position (e.g., FIG. 4A) and the second rotational position (e.g., FIG. 4B). In some embodiments, the one or more cam motors 104 may be disposed on the cleaning robot 50, such as within the wheel assembly 59 or otherwise. In some embodiments, the cam motor 104 may be mounted to the chassis 52 so as to resist rotation or other movement in reaction to rotational forces applied to the cam 102. In some embodiments, the cam motor 104 may be a stepper motor that may divide its motor rotations into a number of steps, which may be equal steps. In some embodiments, such a stepper motor's rotational position may be rotated and held at a particular known position without additional positional sensor feedback to determine positions of the cam 102. In some embodiments, other types of motors may be used consistent with the disclosure.

In some embodiments, the rotational forces generated by the one or more cam motors 104 may be translated to the cam 102 via a cam axle 106. In some embodiments, the cam axle 106 may pass through a portion of the chassis 52 and/or a cam collar 108. In some embodiments, the cam collar 108 may apply a clamping force to the chassis 52, thereby holding the cam 102 and cam motor 104 stationary with respect to the chassis 52. In some embodiments, the cam axle 106 may be received within an axle orifice 107 formed in the cam 102. The axle orifice 107 may be offset from the center of the cam 102 so as to define a varying radial distance between the cam axle 106 and the curved circumferential edge 109 of the cam. The varying radial distance may serve to provide variable chassis height adjustments via the active suspension system 100.

The active suspension system 100 may also include a cam follower 110 that may be mounted or otherwise coupled to the arm 60 of the wheel assembly 59. In some embodiments, the cam follower 110 may be mounted on a top portion 66 of the arm 60 such that a contact surface 111 of the cam follower may be in slidable contact with the circumferential edge 109 of the cam 102. In some embodiments, the top portion 66 of the arm 60 may act as the cam follower 110 and contact surface 111 without a mounted cam. In some embodiments, the arm 60 and cam follower 110 may be biased against the cam 102 by a spring or other mechanism, or the weight of the chassis 52 connected to cam may bias the cam toward the contact surface 111. Accordingly, in some embodiments, as the cam 102 rotates about the cam axle 106, the circumferential edge 109 of the cam may slide along the contact surface 111 of the cam follower 110. In some embodiments, because of varying radial distance between the cam axle 106 and the cam edge 109, the cam 102 may push against the cam follower 110 as the cam rotates in a first rotational direction 114. Although the first rotational direction 114 is indicated as counterclockwise in FIG. 4A, those skilled in the art will understand that different configurations of the cam 102 and the active suspension system 100 may have similar results using different rotational directions within the scope of the disclosure.

In some embodiments, as the cam 102 rotates in the first rotational direction 114 with respect to the chassis 52, a cam distance 112 may increase. In some embodiments, the cam distance 112 may be defined as a radial distance between the cam axle 106 and the contact surface 111 of the cam follower 110. FIG. 4A shows a non-limiting example of a first rotational position of the cam 102 resulting in a first cam distance 112A. FIG. 4B shows a non-limiting example of a second rotational position of the cam 102 resulting in a second cam distance 112B. In some embodiments, moving the cam 102 between the first rotational position (FIG. 4A) and the second rotational position (FIG. 4B) may result in moving the arm 60 between a first position (FIG. 3A) of the active suspension system 100 corresponding to a first cam distance 112A and a first clearance height 68A and a second position (FIG. 3B) corresponding to a second cam distance 112B and a second clearance height 68B.

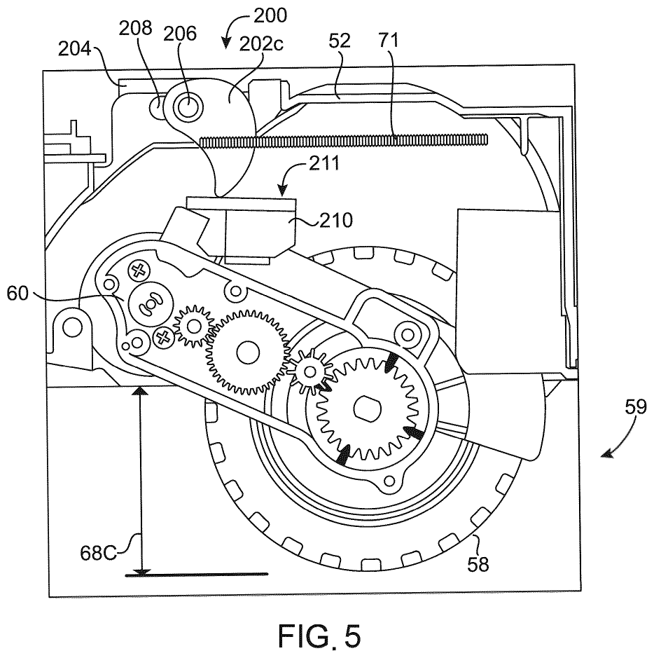

Those skilled in the art will recognize that the first and second rotational positions and resulting in the first and second clearance heights are merely exemplary, and that virtually infinite rotational positions and respective cam distances and corresponding clearance heights may be achieved using the principles of this disclosure. Additionally, it is contemplated that the illustrated shapes of the cam 102 cam follower 110 shown in FIGS. 3-4 are merely one example of a cam shape and that many other cam shapes may be used consistent with the scope of the disclosure. For example, FIG. 5 shows an embodiment of an active suspension system 200 that may include a cam follower 210 having a different shape than the cam follower 110 that may result in providing a different range of potential clearance heights 68C between the floor and the chassis 52. The active suspension system 200 may include a cam motor 204 that may selective rotate the cam 202 by applying torque to a cam axle 206 that may be disposed through an axle orifice 207 in the cam 202. The cam follower 210 may have a larger vertical dimension than the cam follower 110 that may provide for varying clearance heights.

In some embodiments, one or more controllers, such as controller 74 shown in FIG. 2A, disposed on the wheel assembly 59, the chassis 52, or elsewhere may be in electronic communication with each cam motor 104 to provide instructions to alter the ride height of the cleaning robot 50 using the active suspension system 100. In some embodiments, the controller 74 may determine a desired chassis clearance height 68 in response to sensory inputs from the cleaning robot's 50 sensors 53 about the robot's environment or characteristics of other robot components (e.g., current draw, rate of rotation, etc.). For example, the a 3D camera or other sensor may identify an obstacle on a target surface where the cleaning robot 50 may be cleaning or otherwise traveling. The 3D camera may transmit visual data related to the obstacle to the controller 74 (e.g., laser point cloud make up, etc.), and the controller may decipher the visual data to determine characteristics of the obstacle, such as a height of the obstacle with respect to the floor or other target surface. Based on the determined height of the obstacle, the controller 74 may determine a desired chassis clearance height 68 that may allow the robot 50 chassis 52 to clear the obstacle. In some embodiments, based on predetermined data for the active suspension system 100 (e.g., reference tables), the controller may then determine what degree of cam 102 rotation may result in the desired clearance height, if any. In other embodiments, the controller 74 may compute a clearance height using other logic, such as adding a predetermined clearance distance to the determined height of the obstacle. In response, the controller may transmit instructions to otherwise cause the active suspension system 100 (e.g., the cam motor 104) to apply the determined degree of cam rotation, thereby rotating the cam 102 to a rotational position that results in the desired clearance height. In some embodiments, this process may be iteratively repeated as additional obstacles are encountered and/or the robot 50 moves through its environment.

### Control of the Active Suspension System

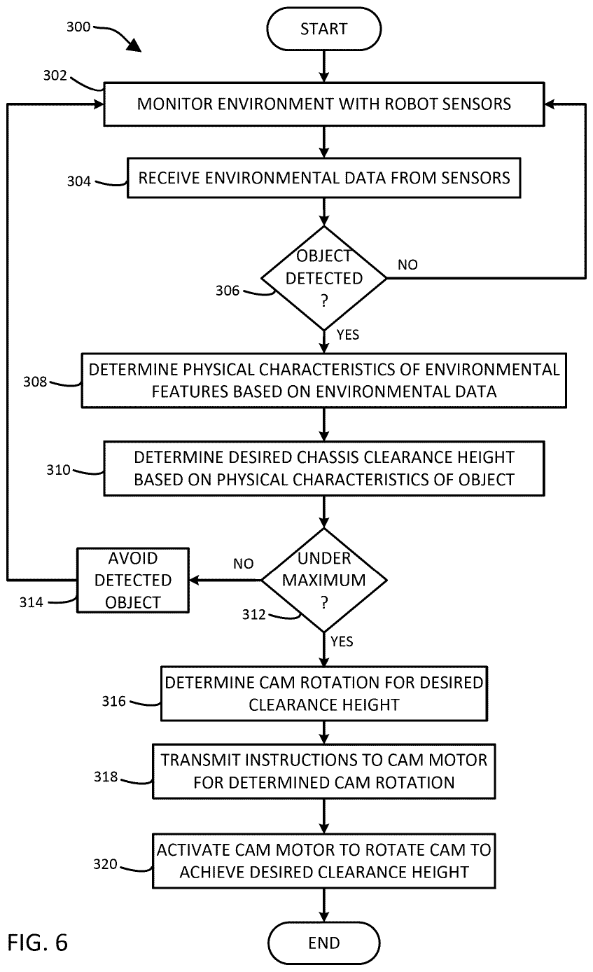

FIG. 6 is a flow chart of an embodiment of a method 300 of adjusting the ride height of the cleaning robot 50 based on sensed information about the robot's surroundings as environmental data. At 302, the robot's sensors may monitor the robots surroundings or environment, transmitting environmental data to one or more controllers, such as controller 74. At 304, the controller may receive the environmental data from the sensors and may analyze the data to determine whether any obstacles or other environmental objects have been sensed or otherwise found in the vicinity of the robot, in the robot's planned path of travel, on the target surface for cleaning, etc. At 306, if no object is detected, the sensors may continue monitoring the environment at 302. If an object is detected at 306, at 308, the controller may determine one or more physical characteristics and/or dimensions of the detected object, such as height, width, depth, etc., based on the environmental data. At 310, based on the determined physical dimensions (e.g., height) of the detected object, the controller may determine a desired chassis clearance height, such as by adding a predetermined buffer height to the detected object height or other suitable method or logic.

At 312, the controller may determine whether the desired chassis clearance height is less than a maximum clearance height that may be particular to the physical capabilities and/or characteristics of the cleaning robot and the active suspension system. If the desired chassis clearance height is more than the maximum clearance height, at 314, the controller may determine that the robot should avoid the detected object or take other alternative action. If the desired chassis clearance height is less than the maximum clearance height, at 316, the controller may determine what cam motor output may be used to achieve the desired chassis clearance height. For example, in embodiments where the cam motor 104 may be a stepper motor, the controller may determine how many steps the motor should rotate to achieve the cam rotation appropriate to reach the desired chassis clearance height. In other embodiments, the active suspension system 100 may include a rotational encoder to provide feedback regarding how much rotation (e.g., degrees, radians, etc.) the cam motor may have rotated the cam axle, and the controller may determine how many degrees of rotation may be appropriate to achieve the desired chassis clearance height. In some embodiments, the information translating the desired chassis clearance height to the appropriate measure of motor input/output may be stored in a look-up table or other database available to the controller. In some embodiments, robot sensors may determine a real-time or substantially real-time clearance height and feed that information back to the controller for the controller to determine whether the desired chassis clearance height has been reached. At 318, the controller may transmit instructions to the cam motor and, at 320, the cam motor may be activated to rotate the cam the appropriate rotational degree determined to achieve the desired chassis clearance height. In some embodiments, the cam motor may continue rotating the cam until the desired clearance height may be achieved as sensed by robot sensors and determined by the controller.

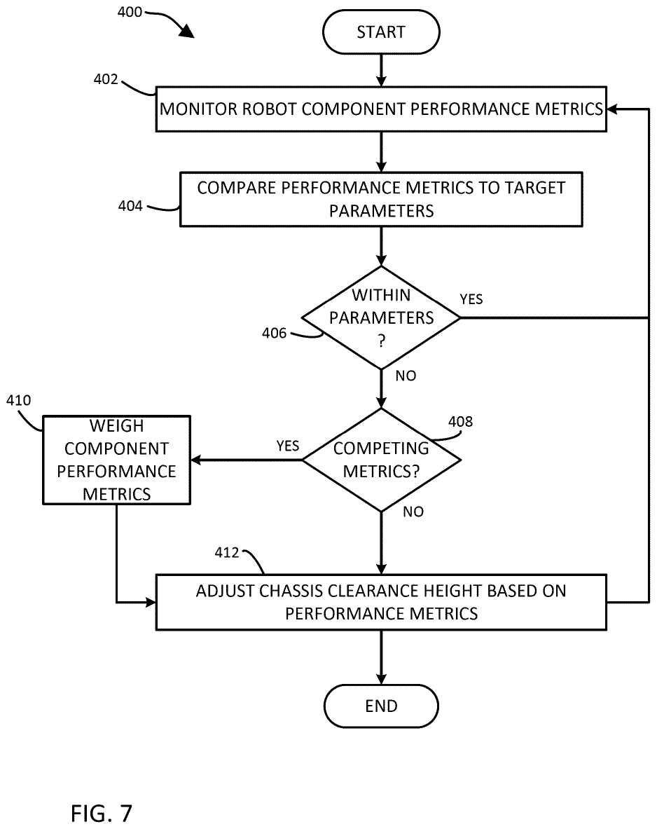

In some embodiments, the one or more controllers may receive feedback from other components of the cleaning robot and use that feedback as inputs for raising and/or lowering chassis 52 using the active suspension system 100. FIG. 7 is a flow chart showing an embodiment of a method 400 for raising/lowering the active suspension system 100 to maintain one or more predetermined cleaning robot performance metrics, such as suction level, brush rotation rate, etc. In some embodiments, such adjustments may provide for improved cleaning performance, power efficiency, battery life, etc. In some embodiments, the controller, such as controller 74, may be in electronic communication with cleaning robot 50 components such as suction motors, vacuum sensors, agitator brush rolls, etc. At 402, the method 400 may include monitoring performance metrics of one or more components of the cleaning robot 50. For example, the cleaning robot may monitor a brush roll speed for an agitator brush included in a vacuum module, the electrical current or power draw for the brush roll or other components, the seal and/or suction of the vacuum, etc. In some embodiments, the seal or suction of the vacuum may be monitored by one or more pressure sensors disposed in the vacuum module so as to be in fluid communication with a suction conduit. A relatively low pressure sensed by the one or more pressure sensors may correspond to a relatively high suction and/or better seal with the target surface, and vice versa. Accordingly, monitoring robot component performance metrics may include monitoring various component activity by a controller in electronic communication with those components or sensors that measure the performance of those components.

At 404, the method may include comparing the measured component performance metrics against target performance parameters for the particular component or measurement. For example, the system may store or determine an optimal brush roll rotation rate or range that may vary based on characteristics of the target surface as may be determined by sensors (e.g., bare floor, low-pile carpet, high-pile carpet, etc.). In some embodiments, the system may store data or information related to an optimal electrical current draw or power draw for a brush motor that may drive the rotation of the brush roll. In some embodiments, an excessive current draw may result from an obstruction or high-resistance characteristics of the target surface (e.g., high-pile carpet), and it may be desirable to reduce the friction level or the resistance level encountered by the brush roll by raising the chassis clearance height and thereby reduce the electrical current drawn by the brush motor to conserve power and/or help prevent damage to the brush motor or other components. In another example, the system may store or determine an optimal suction level or range of levels, which may vary based on target surface characteristics. In some embodiments, the system may also store an optimal current draw or range of current draw for the suction motor and alter the chassis clearance height to conserve power and/or help prevent damage to the motor. In some embodiments, the robot may continuously or periodically monitor the performance parameters while traversing a first surface type (e.g., bare floor). When the robot detects that it has transitioned to a second surface (e.g., carpet) that is different than the first surface type, either by detecting a sudden change in the monitored performance parameters or by using one or more sensors (e.g., an ultrasonic floor-type sensor, proximity sensors, optical sensors, sonar, LIDAR, infrared (IR) sensors, ultrasonic sensors, 2D and/or 3D cameras, photosensors, etc.) configured to detect the type of surface that the robot is traversing, the robot may adjust the robot's chassis clearance height to bring the performance parameters to match their values from the preceding floor type or to match target performance parameters for the second surface type. In some embodiments, such a control method may help mitigate brush roll baseline currents changing over time as parts wear or debris accumulated around the brush, and/or other robot conditions.

At 406, if the measured performance metrics fall within the target parameters or within a predetermined margin of error, the method 400 may include continuing to monitor the robot component performance metrics. In some embodiments, if one or more performance metrics may be determined to fall outside the target parameters or range of parameters, the method 400 may include, at 408, determining whether the off-target metrics are competing metrics. In some embodiments, competing metrics may be performance metrics for which actions to bring one of the competing performance metrics to within the target parameters may bring another of the competing performance metrics further from its target parameter. For example, in some embodiments, the controller may determine that the brush roll rotation rate may be lower than the target parameter, which may indicate that controller should instruct the active suspension system 100 raise the chassis clearance height (and therefore the brush roll) to reduce the resistance encountered by the brush roll and increase the brush roll rotation rate. At the same time, the controller may simultaneously determine that the suction level may be lower than its target parameter, which may indicate that the controller should instruct the active suspension system 100 to lower the chassis clearance height to improve the vacuum seal and increase the suction level. Because the remediating action (e.g., raising or lowering the chassis clearance height) to improve one performance metric may worsen another performance metric, those performance metrics may be considered as competing metrics. If no competing metrics are present at 408, the controller may, at 412, instruct the active suspension system 100 to raise/lower the wheels to adjust the chassis clearance height based on the performance metrics. For example, if the current draw for the brush roll motor is determined to be higher than its respective target parameter, the controller may instruct the active suspension system to raise the chassis clearance height, which may thereby reduce the resistance encountered by the brush roll and reduce the current draw of the brush roll motor.

If, at 408, competing metrics are present, at 410, in some embodiments, the controller may weigh the competing metrics to determine which, if any, of the off-target parameters should be addressed. In some embodiments, the weighing of different component performance metrics may be predetermined for any given scenario. For example, in some embodiments, maintaining a target current draw for the brush roll motor may be more heavily weighted (i.e., more important) than maintaining optimal vacuum suction (or vice versa). In some embodiments, the weighting of different performance metrics may vary situationally based on various factors, such as remaining battery life, programing mode, flooring characteristics, user preferences, load levels over time, time duration of off-target metrics, etc. Once the controller has determined the more heavily weighted performance metric for a given situation, the controller may, at 412, instruct the active suspension system 100 to raise/lower the wheels to adjust the chassis clearance height based on the performance metrics. In some embodiments, when the controller identifies competing performance metrics, the robot may initiate alternative options in addition to just choosing one performance metric over another. For example, if as in the example above, the controller determines that the brush roll rotation rate may be lower than the target parameter and that the suction level may be lower than its target parameter, the controller may determine that the chassis height should be lowered to increase suction but that the bush roll rotation should be stopped so as to conserve battery life or reduce wear on the brush roll. Those skilled in the art will recognize that the method 400 may be performed iteratively in either a continuous fashion or at predetermined intervals so that the active suspension system may make near-constant adjustments in an effort to optimize the cleaning robot's performance and/or efficiency.

### Other Active Suspension System Configurations

While the embodiments of the active suspension system 100 shown and described with reference to FIGS. 2-4 is described as including one or more rotatable cams each driven by a cam motor, other embodiments are contemplated herein to achieve the goal of adjusting the chassis clearance height of the cleaning robot 50 and/or for setting a hard stop representing a limit for travel of a suspension system. In each embodiment of the active suspension system disclosed herein, it is contemplated that similar feedback/control relationships may exist between robot sensors, one or more controllers, and the active suspension system regardless of the specific components making up each particular embodiment of the active suspension system.

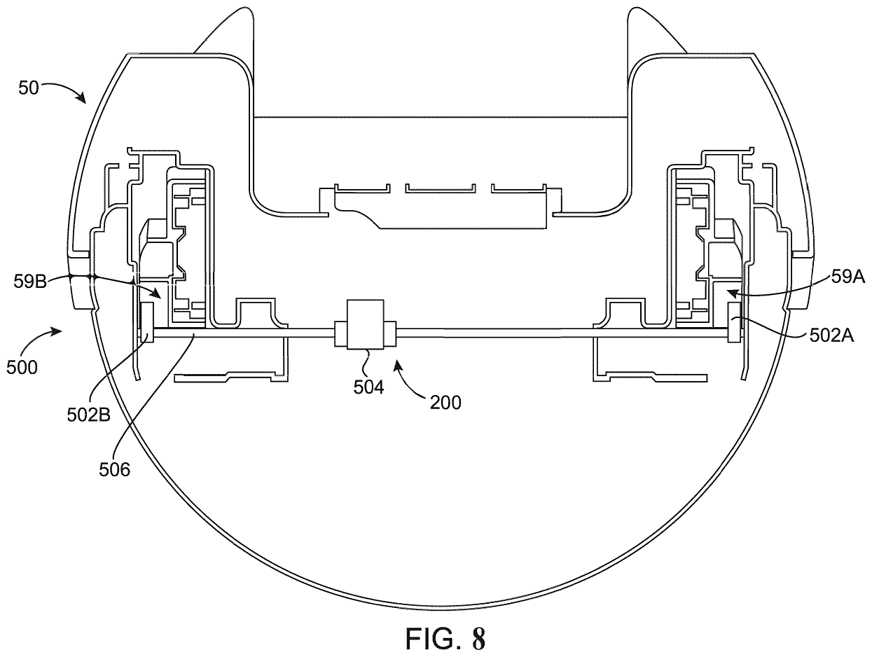

FIG. 8 shows an embodiment of an active suspension system 500 that may include a single cam motor 504. In such an embodiment, the cam motor 504 may be mounted to the chassis 52 and may be configured to selectively rotate a cam axle 506 that may be coupled to multiple cams 502A, B. For example, in some embodiments, a first cam 502A may be disposed on a first end of the cam axle 506 and configured to actuate the wheel assembly 59A, and a second cam 502B may be disposed on a second end of the cam axle and configured to actuate the wheel assembly 59B. In some embodiments, the cam axle 506 may include multiple segments that may transfer rotational torque to one another via one or more gears or gear trains.

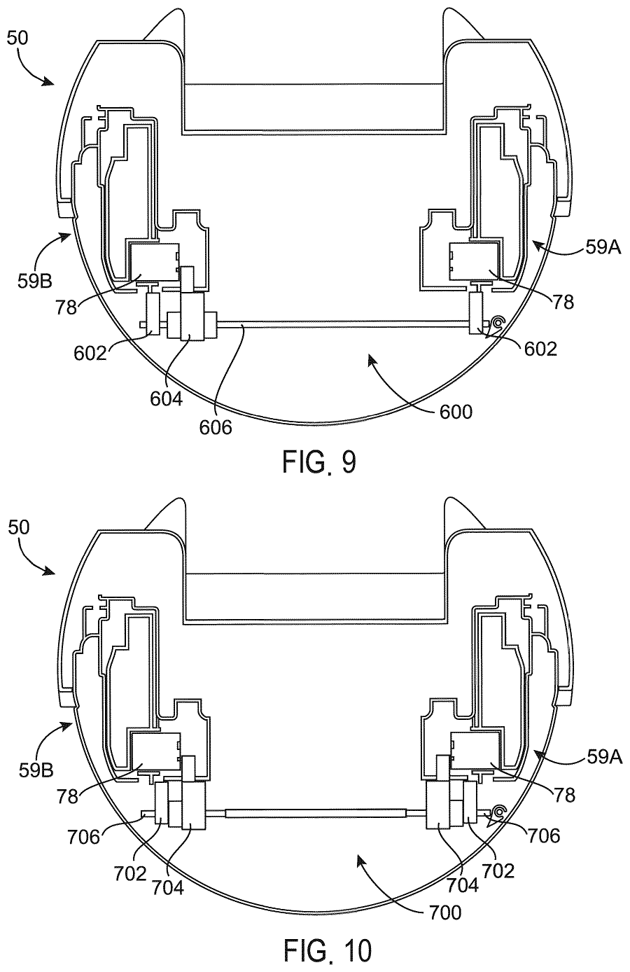

FIG. 9 shows an embodiment of an active suspension system 600 that may divert power from one or more drive motors 78 to power rotation of one or more cams 602. For example, in some embodiments, a clutch 604 may be configured to selectively utilize power or rotational torque generated by the drive motors 78 that may also be configured to drive the wheels of the cleaning robot 50. The clutch 604 may disengage from a cam axle 606 when no cam rotation may be needed, and my reengage with the cam axle when the controller determines that the active suspension system is needed to adjust the chassis clearance height. FIG. 10 shows another embodiment of an active suspension system 700 that may divert power from multiple drive motors 78 to power rotation of one or more cams 702. Such a system 700 may include multiple clutches 704 that may divert power from multiple drive motors 78. Each clutch 704 may be configured to selectively utilize power or rotational torque generated by the drive motors 78 that may also be configured to drive the wheels of the cleaning robot 50. Each clutch 704 may disengage from a respective cam axle 706 when no cam rotation may be needed, and my reengage with the respective cam axle when the controller determines that the active suspension system is needed to adjust the chassis clearance height.

The cleaning robot 50 may alternatively or additionally include other embodiments of the active suspension system that may be utilized consistent with the disclosure. For example, in some embodiments, the robot 50 may include a magnetorheological damper system included on one or more cams. The dampers may be filled with magnetorheological fluid, which may be a mixture of easily magnetized iron particles in a synthetic hydrocarbon oil. In some embodiments, one or more dampener tubes may be included on each cam. Each of the monotube dampers may include a piston containing two electromagnetic coils and two small fluid passages through the piston. The electromagnets may be configured to create a variable magnetic field across the fluid passages. When the magnets are off, the fluid may travel through the passages freely. When the magnets are turned on, the iron particles in the fluid may create a fibrous structure through the passages in the same direction as the magnetic field. The strength of the bonds between the magnetized iron particles may cause the effective viscosity of the fluid to increase, resulting in a stiffer suspension in the wheel assemblies. In some embodiments, the stiffer suspension may establish a hard stop for the robot's passive suspension system. In some embodiments, altering the strength of the current may result in an instantaneous change in force of the piston. If the sensors sense any body roll or change in surface, they may communicate the information to an electrical control unit (ECU). The ECU may compensate for this by changing the strength of the current to the appropriate dampers.

In some embodiments, instead of or in addition to the cam systems described herein, the active suspension system may use a rack and pinion system to move the wheels toward and/or away from the chassis, thereby raising and/or lowering the chassis with respect to the target surface. The rack and pinion may include a rotating gear configured to be rotated by one or more motors, and may include a pinion disposed on the arm of the wheel assembly to transmit the rotational input of the motor to a linear vertical movement of the arm and/or corresponding wheel.

In some embodiments, a linear actuator may be used instead of or in addition to the cam systems described herein. In such a system, a motor for the linear actuator may be mounted to the chassis of the robotic cleaner and an actuatable arm may contact the arm of the wheel assembly. The linear actuation may move the arm and/or wheel away from the chassis, raising the chassis further from the target surface. In some embodiments, any combination of the actuators described herein may be used in tandem or per a given environmental scenario or other situation.

In some embodiments, the one or more caster wheels, such as caster wheel may also be vertically adjustable by a cam system, a rack and pinion system, corkscrew lift, or another suitable lifting/lowering mechanism. In some embodiments, the caster wheel may be configured to be raised and/or lowered in conjunction with the driven wheels in the wheel assemblies via a drive train and/or gear trains transmitting the rotational torque supplied by the cam motor to a similar cam system corresponding to the caster wheel. In some embodiments, an independent cam motor, linear actuator, or other motor may be disposed on the chassis to vertically adjust the caster wheel in a similar manner to that described herein with respect to the driven wheels. In some embodiments, any combination of the actuators described herein may be used in tandem or per a given environmental scenario or other situation.

### Active Suspension to Increase Mopping Pressure

In some embodiments, the active suspension system may be used adjust the mopping pressure applied by the cleaning robot 50 in one or more scenarios. For example, in some embodiments, the cleaning robot 50 may include a mopping mode or a wet cleaning mode in which a cleaning pad (such as cleaning pad 67 from FIG. 1A) may be implemented to scrub the target surface using a liquid cleaner. In some embodiments, the liquid cleaner may be applied to the cleaning pad with a liquid applicator, or may be applied directly to the target surface such as with a jet or other liquid application mechanism. In some embodiments, the liquid cleaner may soak through the cleaning pad after being applied from an application point on the top of the cleaning pad.

In some embodiments, when the cleaning robot 50 may be in mopping mode, either by manual selection by a user or via other automated processes, the active suspension system 100 may invert suspension to increase downward pressure from the cleaning pad 67 to the target surface. Increased downward pressure applied by the cleaning pad 67 may increase friction between the cleaning pad and the target surface, and may therefore increase cleaning effectiveness. In some embodiments, downward pressure applied by the cleaning pad 67 may be provided by reducing the clearance height (such as clearance height 68A, B shown in FIGS. 4A-B) between the bottom of the wheels 58 and a lower surface on the lower portion 56 of the chassis 52 of the cleaning robot 50. In other words, when in mopping mode, the active suspension system 100 may retract the wheels 58A, B such that a smaller proportion of the cleaning robot's overall weight may be supported by the wheels, and a relatively larger proportion of the cleaning robot's overall weight may be supported by the cleaning pad 67 itself. Such a shift in weight distribution may increase the friction between the cleaning pad 67 and the target surface, which may increase the cleaning effectiveness of the cleaning pad.

In some embodiments, the cleaning robot 50 may increase the cleaning pad 67 pressure automatically when mopping mode is initiated (either manually or through an automated process). In some embodiments, the cleaning robot 50 may increase the cleaning pad 67 pressure based on environmental factors sensed by one or more of the cleaning robot's sensors, such as sensors 53. For example, in some embodiments, a pressure sensor may determine whether the pressure being applied by the cleaning pad 67 to the target surface meets a predetermined or dynamic value for pressure that may be effective for mopping. In some such embodiments, a pressure sensor may be disposed on the cleaning robot 50 between the cleaning pad 67 and the chassis 52 of the cleaning robot that may experience varying pressure readings when the cleaning pad presses against the target surface and accordingly presses correspondingly upward against the cleaning robot chassis. If the pressure as read by the pressure sensor and received by a controller, such as controller 74, is less than a predetermined optimal value for pressure in a particular mode, such as a mopping mode, the active suspension system 100 may retract the wheels 58A, B to increase that pressure. Conversely, if the controller 74 determines that the pressure read by the pressure sensors is more than the predetermined optimal value, the active suspension system 100 may extend the wheels 58A, B so as to reduce the pressure between the target surface and the cleaning pad 67. In some embodiments, a similar procedure could be implemented by detecting levels of slippage between the cleaning pad 67 and the target surface. In such embodiments, if slippage may be determined to be higher than an optimal slippage value, the controller 74 may instruct the active suspension system 100 to retract the wheels 58A, B, which may increase friction between the cleaning pad 67 and the target surface, thereby reducing slippage. Similarly, if the controller 74 determines that a detected slippage value may be less than optimal, the controller may instruct the active suspension system 100 to extend the wheels 58A, B to reduce the friction between the cleaning pad 67 and the target surface, thereby reducing friction and potentially increasing slippage.

In some embodiments other sensors, such as optical sensors or cameras, may detect particularly soiled areas on the target surface that may benefit from increased pressure and agitation from the cleaning pad 67. For example, in some embodiments, a camera may see a portion of the floor with a particular discoloration or texture (e.g., dirt, food stain, etc.), and the controller 74 may interpret the image to be a soiled portion of the target surface. In such embodiments, the active suspension system 100 may retract the wheels 58A, B toward the chassis 52 of the cleaning robot 50 so as to increase the pressure applied by the cleaning pad 67 at or in the vicinity of the soiled portion of the target surface. When the camera or other sensors 53 determine that the soiled area has been sufficiently cleaned and/or the camera or sensors no longer detects the soiled area, the controller 74 may instruct the active suspension system 100 to extend the wheels 58A, B away from the chassis 52 and thereby reduce the pressure applied to the floor by the cleaning pad 67.

In some embodiments, a moisture sensor may sense a moisture level in the cleaning pad 67 and may adjust wheel height and clearance accordingly. For example, in some embodiments, when the moisture level sensed by the moisture sensor and determined by the controller 74 may exceed a predetermined threshold moisture level, the controller may instruct the active suspension system 100 to extend the wheels 58A, B and provide additional clearance due to increased thickness of the cleaning pad 67.

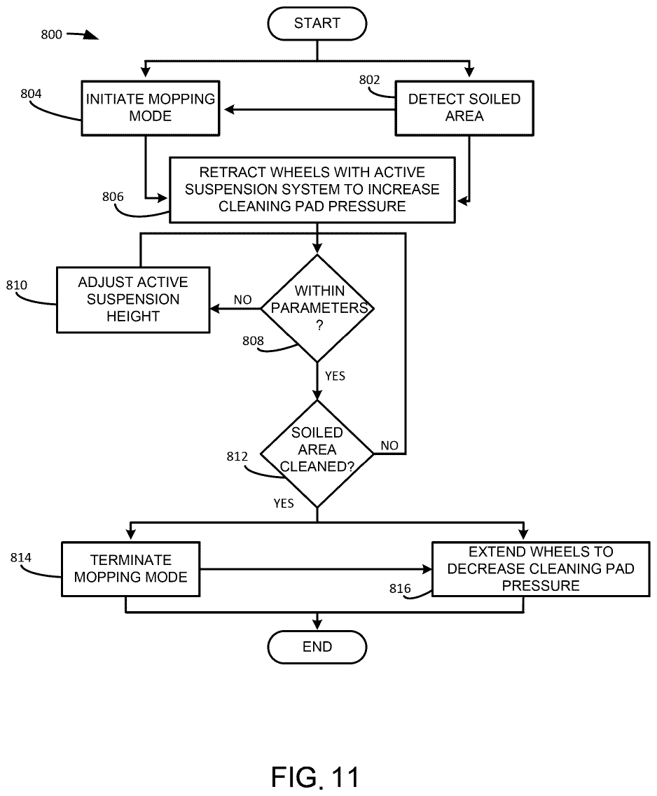

FIG. 11 shows a flows chart of an embodiment of a method 800 of using the active suspension system to increase mopping pressure in various operation modes for various reasons. At 802, sensors on the cleaning robot, such as sensors 53, may identify and the controller, such as controller 74, may determine that an area of the target surface may be particularly soiled. In some embodiments, detection of a soiled area may automatically initiate mopping mode at 804, or in some embodiments mopping mode may be initiated manually, on a schedule, or for other reasons. At 806, in response to mopping mode being activated or to the detection of a soiled area, the active suspension system 100 may retract the wheels 58A, B of the cleaning robot 50 to increase the pressure between the cleaning pad 67 and the target surface, as described above. In some embodiments, the increased cleaning pad 67 pressure may apply additional cleaning power to the soiled area due to the increased friction between the cleaning pad and the target surface. At 808, the controller 74 may determine, based on inputs from sensors or through other suitable methods, whether certain predetermined parameters may be within desired or optimal ranges. For example, a pressure sensor may detect the pressure being applied to the target surface to determine whether the sensed pressure may be above or below a threshold pressure level. If, at 808, the detected parameters may not be within optimal ranges, the active suspension system 100 may adjust the suspension and/or wheel height in a direction that may bring the detected parameter nearer to or into the preferred optimal range at 810. For example, if the sense pressure may be lower than a preferred threshold pressure level, the active suspension system 100 may retract the wheels 58A, B to increase the down force applied to the cleaning pad 67 and thereby increase cleaning pad pressure.

If the detected parameters at 808 are within the preferred ranges, at 812, the cleaning robot 50 may determine, such as using sensors, whether the soiled area has been adequately cleaned. If not, then the method may include continuing to monitor the cleaning parameters at 808 until the soiled area may be determined to be clean. If yes, in some embodiments, the cleaning robot 50 may, at 814, terminate mopping mode or, at 816, the active suspension system 100 may extend the wheels 58A, B to decrease the cleaning pad pressure applied to the target area. In some embodiments, terminating mopping mode may itself cause the active suspension system 100 to extend the wheels 58A, B to reduce cleaning pad pressure. In other embodiments, mopping mode may continue and the pressure may be increased when the cleaning robot 50 detects other soiled areas that may benefit from increased mopping pressure. In some embodiments, the detection of the soiled area or initiation of mopping mode may trigger other actions by the robot 50, such as dispensing of cleaning fluid onto the target surface or the cleaning pad 67, for example.

### Active Suspension to Support Robot Mobility

In some embodiments, the active suspension system 100 may help free the cleaning robot 50 in scenarios where its movement may be restricted or otherwise unable to move properly. For example, in some instances, the cleaning robot 50 or a portion of the cleaning robot may become constrained from movement, such as between a piece of furniture and the floor or other target surface, which may prevent or restrict the cleaning robot from moving across the target surface for cleaning. In some such embodiments, the upper portion 54 of the cleaning robot 50 may abut a piece of furniture pressing downward to created sufficient pressure against the wheels 58A, B such that the wheels may not be able to overcome the friction between the chassis 52 of the cleaning robot 50 and the furniture. In other instances, a portion of the cleaning robot 50 may become positioned on top of a raised piece of furniture, such as a lamp stand, a pet food bowl, desk or chair legs, etc., which may restrict robot mobility. In such scenarios, one or more of the wheels 58A, B may be suspended above the target surface such that the wheels may not provide any driving power to move the cleaning robot 50.

In some embodiments, the cleaning robot 50, such as via the controller 74 and one or more sensors, such as sensors 53, may detect that the robot's movement may be restricted and may use the active suspension system 100 to free the cleaning robot 50 for movement. For example, a tilt sensor or other sensor that may detect the tilt angle of the cleaning robot 50 may determine that it may exceed an angle by which one or more wheels 58A, B may have contact with the target surface, or the angle of the chassis 52 itself. It may also be detected that one or more wheels 58A, B may be spinning with little or no resistance as compared to the resistance encountered while driving, or that the pressure encountered by the wheel or suspension system has reduced such that the wheel may be determined to be clear of the floor or at least that the friction between the floor and the wheel may be reduced enough to minimize traction. In some embodiments, the wheel resistance may be determined by monitoring the electrical current levels of the one or more drive motors 78. For example, when current levels for one or more drive motors 78 drop below a threshold current level, it may indicate that the wheel 58A, B may be slipping on the target surface or may be clear of the surface altogether.

In such scenarios, the controller 74 may instruct the active suspension system 100 to extend one or both wheels 58A, B in a direction away from the body of the cleaning robot 50 and toward the floor, effectively increasing the clearance height (e.g., 68A, B) of the cleaning robot. Extending the wheels 58A, B downward may cause the wheels to make contact with the floor or other surface and may allow them to regain traction. Additionally, increasing the chassis clearance may provide the clearance needed for the chassis 52 to clear the obstacle it may have previously been hung-up upon, and allow the cleaning robot 50 to drive clear. In some embodiments, the active suspension system 100 may extend clearance of only one wheel 58A, B, for example, the wheel that has been determined to be slipping or to have lost contact with the floor. In some embodiments, the clearance of both wheels 58A, B may be increased to provide additional chassis clearance for the chassis 52 of the cleaning robot 50.

In embodiments where the cleaning robot 50 may detect that its movement may be restricted due to positioning underneath furniture or wedged between the furniture and the floor, the controller 74 may instruct the active suspension system 100 to retract the wheels 58A, B toward the chassis 52, which may reduce the chassis clearance 68A, B and overall may lower the effective clearance of the entire cleaning robot. For example, in some embodiments, a pressure sensor may detect that downward force on the wheels 58A, B may have increased above a force threshold value or range of values such that the controller 74 may determine that the cleaning robot 50 may be restricted or limited in its movements. Similarly, if the pressure sensor may detect that downward force on the wheels 58A, B may have decreased below the force threshold value or range of values such that the controller 74 may determine that the cleaning robot 50 may be restricted or limited in its movements. In some embodiments, an increase in electrical current in one or more drive motors 78 may be detected, which may indicate that the wheels 58A, B may be unable to rotate due to above-threshold downward force acting on the cleaning robot 50. In such scenarios, the controller 74 may instruct the active suspension system 100 to retract the wheels 58A, B so as to lower the chassis 52 clearance 68 and free the cleaning robot 50 for more freedom of movement.

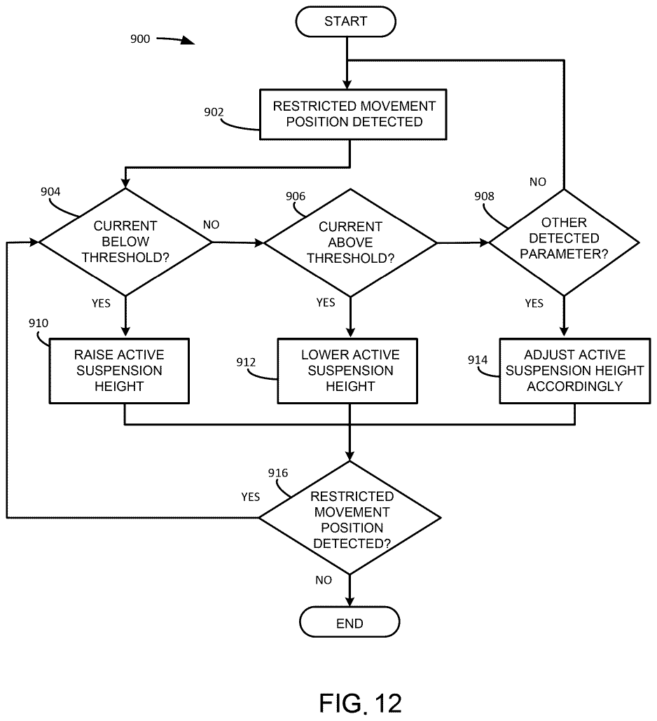

FIG. 12 is a flow chart of an embodiment of a method 900 of using the active suspension system 100 to free the cleaning robot 50 from a position in which its mobility may be restricted. At 902, a restricted mobility position may be detected via one or more sensors on the cleaning robot and/or the controller 74, such as the sensors 53. At 904, the method may include determining whether an electrical current used by one or more of the drive motors 78 for the wheels 58A, B may be below a minimum current threshold, which may indicate that one or more of the wheels may be slipping or has lost contact with the floor due to being hung up on an object or furniture. If the current is determined to be below the current threshold, at 910, the active suspension system 100 may raise the active suspension height (e.g., chassis clearance 68) for one or more of the wheels 58A, B in order to free the cleaning robot 50 from the obstruction. At 906, the method may include determining whether an electrical current used by the one or more drive motors 78 may be above a maximum current threshold, which may indicate that the cleaning robot 50 may be between an object and the floor in a position of restricted mobility. If yes, at 912, the active suspension system 100 may lower the active suspension height, which may lower the overall clearance of the cleaning robot 50 and free it from the restricted mobility position. At 908, the method may include determining whether any other parameters may be detected that may indicate whether the cleaning robot's 50 mobility may be restricted due to positioning on top of an object, beneath an object, or otherwise. If yes, at 914, the active suspension system 100 may include adjusting the suspension height accordingly in attempt to free the cleaning robot 50 from the restricted mobility position. At 916, the method may include detecting whether the cleaning robot 50 remains in a position of restricted mobility. If yes, the method may include iterating the process described in 904-914 to free the cleaning robot from the restricted mobility position.

### Stopping Brush Rolls When Not in Use

In some embodiments, the active suspension system 100 may be used to preserve battery life or otherwise reduce power usage, such as by stopping or reducing the use of certain robot components when the may not be being used. For example, as described herein, in various scenarios, it may be advantageous for the active suspension system 100 of the cleaning robot 50 to increase the chassis clearance height 68 under the chassis 52 such as by extending the wheels 58A, B away from the body of the cleaning robot. In some embodiments, this may be done to avoid obstacles (e.g. electrical cords, toys, etc.), adjust suction, etc. In some such scenarios, certain components of the cleaning robot 50, such as the brush roll, may no longer contact the target surface or may otherwise not be used in the current cleaning mode. For example, the brush roll may be disposed on the lower portion 56 of the cleaning vacuum 50 near the vacuum, and may agitate debris (e.g., dust, dirt, food particles, etc.) that may be otherwise adhered to the target surface so that the vacuum may pull them into the cleaning robot and thereby clean the target surface. However, in some embodiments where the active suspension system 100 may increase the chassis clearance 68 to a height that the brush roll may no longer be effective (e.g., no longer contacts the target surface), the controller 74 may be configured to turn off the brush roll such as by instructing a brush roll motor to stop rotating the brush roll. By doing so, the cleaning robot 50 may conserve battery life by not expending power to rotate the brush roll when it may not be effectively agitating debris for cleaning due to the chassis clearance height, or if a particular cleaning mode may not actively use the brush roll.

In some embodiments, the controller 74 may instruct the brush roll motor to stop any time that the active suspension system 100 may extend the chassis height 68 beyond a predetermined threshold height such that the brush roll may no longer be effective or may interfere with an action (e.g., clearing an object). Such an object for clearance may be identified in a variety of ways using a variety of sensors, such as using a camera, LIDAR, etc. In some embodiments, the brush roll motor may be configured to stop or slow down rotation of the brush roll when an electrical current draw from the brush roll motor may fall below a minimum threshold current level. In some embodiments, when the brush roll motor current may fall below a minimum level, it may indicate that the brush roll may be encountering very little resistance and therefore may have been lifted clear of the target surface. In some embodiments, the brush roll motor may then periodically rotate the brush roll to monitor current draw and may determine, such as with the help of the controller 74, whether the current draw may increase beyond the minimum current level and that therefore the brush roll may be in contact with the floor again. In some embodiments, the brush roll may not stop, but may instead be reduced to a minimum speed such that the motor may detect an increase in current levels and therefore that the brush roll may be in contact with the floor or other target surface again. In some embodiments, monitoring of the brush roll current may be used in conjunction with other sensors, such as cameras, LIDAR, proximity sensors, etc., to determine whether the cleaning robot 50 may be encountering an obstacle or may have cleared an obstacle such that active suspension system 100 may extend or retract the wheels 58A, B.

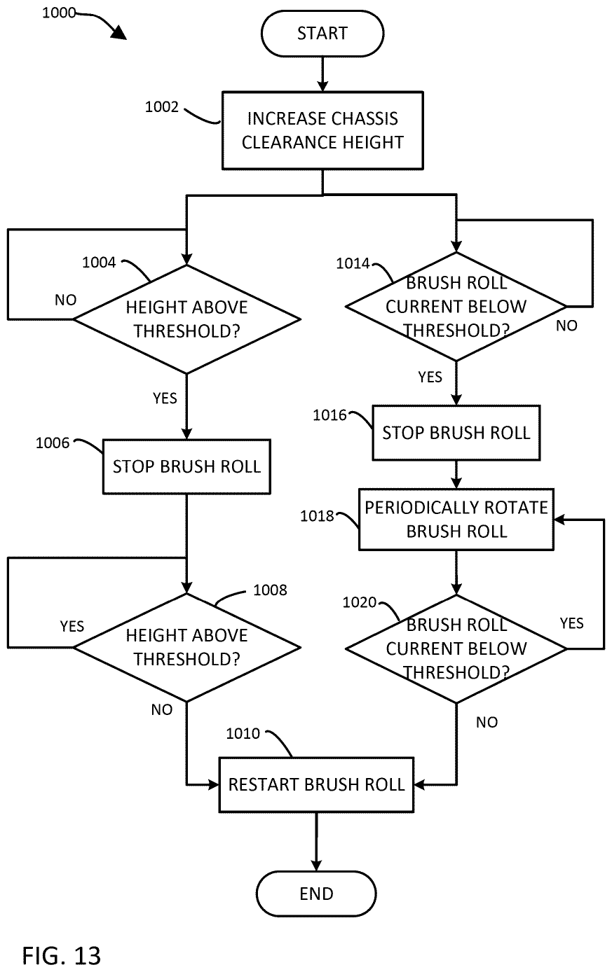

FIG. 13 a flow chart of an embodiment of a method 1000 of using the active suspension system 100 to preserve robot battery life and energy efficiency by stopping or slowing certain robot components in certain scenarios. At 1002, the method may include using the active suspension system 100 to increase the chassis clearance height 68 for one or more of the scenarios described herein or others. At 1004, the method may include determining whether the chassis clearance height is above a threshold chassis clearance height. If not, the robot 50 and/or controller 74 may monitor the chassis clearance either continually or periodically. If the chassis clearance height exceeds the threshold, at 1006, the method may include stopping the brush roll to, among other things, conserve battery power or other wear while the clearance height may be such that continued rotation of the brush roll may be less effective or efficient. At 1008, the method may include continually or periodically monitoring the chassis clearance height 68 to determine whether the clearance height remains above the threshold chassis clearance height or whether the chassis clearance height has dropped below the threshold. If the chassis clearance height is no longer above the threshold clearance height, the method may include restarting the brush roll.

In some embodiments, the method may also include, once the chassis clearance height 68 has been increased at 1002, monitoring the current used by the brush roll motor to determine, at 1014, whether the current used by the brush roll motor (i.e., “brush roll current”), is above or below a minimum threshold current level. If the current is not below the minimum threshold current level, the method may include continuing to monitor the current level either continuously or periodically. If the controller or the robot otherwise determine that the brush roll current is below the minimum threshold current level, at 1016, the robot and/or controller may stop the brush roll motor from rotating the brush roll in order to, for example, conserve battery power or otherwise increase efficiency. In some embodiments, the method may include, at 1018, the brush roll motor periodically rotating or attempting to rotate the brush roll in order to monitor how much current the motor draws in causing those rotations. If, at 1020, it is determined that the brush roll current remains below the minimum threshold current level, the method may include continuing to periodically rotate and monitor the brush roll current. If the brush roll current increases above the minimum threshold current level, the method may include, at 1010, restarting the brush roll.

The foregoing description and drawings merely explain and illustrate the invention and the invention is not limited thereto. While the specification is described in relation to certain implementation or embodiments, many details are set forth for the purpose of illustration. Thus, the foregoing merely illustrates the principles of the invention. For example, the invention may have other specific forms without departing from its spirit or essential characteristic. The described arrangements are illustrative and not restrictive. To those skilled in the art, the invention is susceptible to additional implementations or embodiments and certain of these details described in this application may be varied considerably without departing from the basic principles of the invention. It will thus be appreciated that those skilled in the art will be able to devise various arrangements which, although not explicitly described or shown herein, embody the principles of the invention and, thus, within its scope and spirit.

What is claimed is:

1. A method of controlling a robotic cleaning device, the method comprising:
detecting, via one or more sensors, a soiled area in on a target surface for cleaning;
activating an active suspension system to reduce the distance between a chassis of the robotic cleaning device and the target surface, thereby increasing pressure applied by a cleaning pad mounted to the chassis of the robotic cleaning device;
monitoring, via one or more processors, one or more parameters of the robotic cleaning device to determine whether the one or more parameters is outside a threshold parameter range;
adjusting the active suspension system if the one or more parameters is outside the threshold parameter range; and
deactivating the active suspension system when the soiled area on the target surface is detected to be cleaned.

2. The method of claim 1, wherein deactivating the active suspension system includes returning the distance between the chassis and the target surface to a default distance.

3. The method of claim 1, wherein the one or more parameters include a pressure sensed between the cleaning pad and the chassis.

4. The method of claim 3 further comprising activating the active suspension system to further reduce the distance between the chassis and the target surface when the pressure is below the threshold parameter range.

5. The method of claim 3 further comprising activating the active suspension system to increase the distance between the chassis and the target surface when the pressure is above the threshold parameter range.

6. The method of claim 1, wherein the one or more parameters include slippage detected between the cleaning pad and the chassis.

7. The method of claim 6 further comprising activating the active suspension system to further reduce the distance between the chassis and the target surface when the detected slippage is above the threshold parameter range.

8. The method of claim 6 further comprising activating the active suspension system to increase the distance between the chassis and the target surface when the detected slippage is below the threshold parameter range.

9. A method of controlling a robotic cleaning device, the method comprising:
detecting a restricted mobility position of the robotic cleaning device;
determining that an electrical current draw for a drive motor controlling rotation of one or more wheels of the robotic cleaning device is above a predetermined current range;
activating an active suspension system to decrease the distance between a chassis of the robotic cleaning device and a target surface based on the determination that the electrical current draw for the drive motor is above the predetermined current range.

10. The method of claim 9 further comprising detecting whether an angle of the chassis exceeds a threshold angle.

11. The method of claim 9, wherein detecting the restricted mobility position may include detecting that a downward force on one or more wheels of the robotic cleaning device exceed a force threshold value.

12. The method of claim 9, wherein the active suspension system decreases the distance between the chassis of the robotic cleaning device by retracting one or more wheels of the robotic cleaning device toward the chassis.

13. A method of controlling a robotic cleaning device, the method comprising:
detecting a restricted mobility position of the robotic cleaning device;
determining that an electrical current draw for a drive motor controlling rotation of one or more wheels of the robotic cleaning device is below a predetermined current range;
activating an active suspension system to increase the distance between a chassis of the robotic cleaning device and a target surface based on the determination that the electrical current draw for the drive motor is below the predetermined current range.

14. The method of claim 13 further comprising detecting whether an angle of the chassis exceeds a threshold angle.

15. The method of claim 14 further comprising increasing the distance between the chassis and the target surface when the angle of the chassis exceeds a threshold angle.

16. The method of claim 13, wherein detecting the restricted mobility position may include detecting that a downward force on one or more wheels of the robotic cleaning device is lower than a force threshold range.

17. The method of claim 13, wherein the active suspension system decreases the increases between the chassis of the robotic cleaning device by extending one or more wheels of the robotic cleaning device away from the chassis.

18. The method of claim 13, wherein the robotic cleaning device includes a first wheel and a second wheel, and wherein increasing the distance between the chassis and the target surface includes extending both the first and the second wheel.

19. The method of claim 13, wherein the robotic cleaning device includes a first wheel driven by a first drive motor and a second wheel driven by a second drive motor, and wherein increasing the distance between the chassis and the target surface includes extending only the first wheel when the electrical current draw for the first drive motor is below the predetermined current range.

20. The method of claim 13, wherein the robotic cleaning device includes a first wheel driven by a first drive motor and a second wheel driven by a second drive motor, and wherein increasing the distance between the chassis and the target surface includes extending only the first wheel and the second wheel when the electrical current draw for the first drive motor and the second drive motor is both below the predetermined current range.
